(19) United States
(12) Patent Application Publication
(10) Pub. No.: US 2011/0240561 A1
(43) Pub. Date: Oct. 6, 2011

(54) Configurations and Methods of Treatment of Silicate-Containing Waste Streams

(75) Inventors: Steven Reynolds, Raleigh, NC (US); Graham Maclean, Richland, WA (US); Clay Coleman, Sugarland, TX (US)

(73) Assignee: FLUOR TECHNOLOGIES CORPORATION, Aliso Viejo, CA (US)

(21) Appl. No.: 13/128,829

(22) PCT Filed: Dec. 1, 2008
(86) PCT No.: PCT/US08/85186

§ 371 Date: Jun. 20, 2011

(51) Int. Cl. C02F 1/52

(52) U.S. Cl. 210/723; 210/198.1

(57) ABSTRACT

Contemplated wastewater treatment plants and processes comprise a unit in which a silicate-containing waste stream is combined with an alkaline process stream to so form a pH-controlled intermediate that is then fed to a reactor in which carbonization effects precipitation of the silicate. Following a particle growth step in the reaction vessel that renders the precipitate suitable for filtration, the so produced silicon dioxide can be safely disposed of in a landfill while the liquid can be discharged or sent to a zero liquid discharge pond to precipitate sodium carbonates.

### FIELD OF THE INVENTION

The field of the invention is treatment of waste streams, especially as it relates to silicate-containing waste streams.

### BACKGROUND OF THE INVENTION

Removal of silicate (e.g., Na2O:SiO2) from water streams has been known for a relatively long time. For example, U.S. Pat. No. 2,963,355 teaches compositions and methods of purifying water using a process in which MgO and Na2CO3 react at elevated temperatures to form MgSiO3, which precipitates. Filtration then affords a treated water stream with 2 to 6 ppm residual silicate and reduced hardness. However, and depending on the starting conditions and materials, the sodium silicates may gel and therefore terminate the process.

Still further, such and other processes (e.g., using a coagulant and microfiltration as described in U.S. Pat. No. 5,904,853) may produce hazardous solids that often fail to meet non-hazardous landfill requirements. The disposal costs for landfills are considerable and the cost difference between non-hazardous and hazardous materials is significant. Moreover, most currently known processes for silicate removal have less than desirable efficiency and a relatively high energy requirement.

In other known reactions involving silicate, SiO2 is produced by reacting silicate with CO2 at 167° F.±5° F. as described in U.S. Pat. No. 2,924,510. This process uses a flue gas like composition having a CO2 concentration of about 10%, and further involves a dilution step to dilute the SiO2 with hot water to assist in a downstream drying process. The end product has reduced moisture content and the particle size is controlled to a size below 0.1 micron. Alternatively, the purity of already formed SiO2 can be further improved by adding a surface active agent to help the drying of the product as taught in U.S. Pat. No. 3,902,915. In still other known processes, a commercial high-surface area SiO2 product with low moisture content is produced from rice husk ash as described in international patent application WO2004/073600A2. Here, silica is solubilized from the ash of the rice husk using NaOH at a temperature of 203° F. and subsequently reacted with CO2 to form SiO2 precipitate with a specific particle size. The precipitate is then filtered and dried for sale, while the NaOH is regenerated from the liquid solution using CaO and heat. Similar processes are employed in the production of a high-surface SiO2 pigment and paper filler as described in international patent application WO 95/03251, and other high-surface silica products are produced from porcellanite rocks as described in EP 0 549 323. While such processes tend to produce relatively pure SiO2 products with defined particle size, various disadvantages remain. Among other things, the removal of the SiO2 precipitate typically requires specialized and relatively expensive filtration steps. Moreover, due to the relatively large surface area, the moisture content is relatively high and the products require significant drying, further adding to the production cost.

Consequently, although many configurations and methods for silicate removal are known in the art, all or almost all of them suffer from one or more disadvantages. Thus, there is still a need to provide methods and configurations for improved silicate removal, especially for waste streams with significant quantities of sodium silicate.

### SUMMARY OF THE INVENTION

The present invention is directed to methods and plant configurations where silicate-containing wastewater streams are processed such as to produce solid products that can be disposed of as non-hazardous products in a conventional landfill. Most preferably, the plants and methods according to the inventive subject matter use carbonation of a silicate-containing solution to precipitate the silicate as SiO2 followed by a particle growth step to render the precipitate filterable, preferably using conventional filter presses. If liquid discharge is not permitted, the so produced filtrate is then evaporated to precipitate sodium carbonate and sodium bicarbonate. The filtrate can also be sent to a wastewater treatment facility.

Thus, in one aspect of the inventive subject matter, a method of treating a silicate-containing wastewater stream includes a step of reacting a silicate-containing solution with CO2 to form dispersed SiO2, and a further step of particle size growth under conditions and for a time effective to produce larger SiO2 particles from the dispersed SiO2, wherein the particles have a size sufficient to allow filtration of the SiO2 particles from the wastewater using conventional filtration methods and devices.

In further especially preferred aspects, the silicate-containing solution is collected or formed in an equalization tank, wherein the tank has a volume sufficient to allow for production of the silicate-containing solution at a maximum composition of 10 wt % Si. It is further preferred that the equalization tank is configured to allow flow and/or the composition of the silicate-containing wastewater streams flowing into the equalization tank to vary in an amount of at least 20%. It is still further especially preferred that filtration is accomplished with a filter press. Most typically, the filter press removes nearly all of the SiO2 particles (e.g., at least 85% on a 1 micron filter press screen, and more typically at least 98% using an 11 micron rated filter paper) and produces a filtrate that has a pH suitable for disposal. Where desired, methods and plants according to the inventive subject matter may further advantageously remove water from the filtrate (e.g., via evaporation pond) to thereby form solid sodium carbonates.

Viewed from a different perspective, contemplated methods of treating a silicate-containing wastewater stream include those in which SiO2 and sodium carbonate solids that are formed are suitable for disposal in a landfill. Most typically, filterable SiO2 particles are formed by precipitation of SiO2 and subsequent particle size enlargement, wherein the precipitation of SiO2 is effected by reaction of the silicate-containing wastewater stream with CO2. It is further preferred that the sodium carbonate and bicarbonate formed in the reaction are precipitated by water removal, and the water removal is typically performed in an evaporation pond. While not limiting to the inventive subject matter, it is generally preferred that the silicate-containing wastewater stream is combined with an alkaline waste stream or alkaline stream to control pH and avoid gelling of the silicate.

Therefore, contemplated wastewater treatment plants will include an equalization tank that is fluidly coupled to a source of a silicate-containing wastewater stream (e.g., production plant for polycrystalline silicon, etc.) and optionally a source of an alkaline stream. A reaction tank is further fluidly coupled to the equalization tank to receive a mixture of the silicate-containing wastewater stream, and is in turn fluidly coupled to a source of CO2. A filtration unit is then fluidly coupled to the reaction tank to receive the product from the reaction tank and is configured to allow removal of insoluble SiO2 from the product and to so form a filtrate.

Especially preferred plants will further comprise an evaporation pond fluidly coupled to the filtration unit to receive the filtrate. Where desired, a pH control unit is coupled to the equalization tank and/or reaction tank to maintain the pH in the equalization tank and/or the reaction tank within a range where the silicate stays dissolved. Additionally or alternatively, a temperature control circuit may be coupled to the equalization tank and/or the reaction tank to maintain a temperature in the equalization tank and/or reaction tank at a predetermined level. In still further preferred aspects, the filtration unit includes a filter press, and/or another type of filter that can remove essentially all of the insoluble SiO2 and produce a filtrate with a reasonable flow rate (e.g., a single industrial filter press can handle flow rates ranging from 50 GPM to several thousand GPM, in addition that several filter presses can be placed in parallel).

Various objects, features, aspects and advantages of the present invention will become more apparent from the following detailed description of preferred embodiments of the invention.

### BRIEF DESCRIPTION OF THE DRAWING

FIG. 1 is an exemplary schematic illustration of a wastewater treatment plant according to the inventive subject matter.

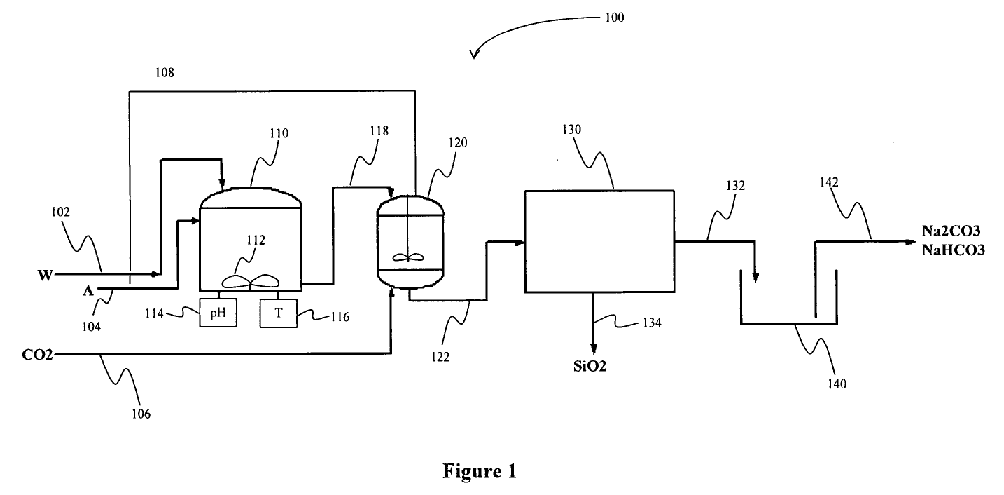

### DETAILED DESCRIPTION

The present invention is directed to plant configurations and methods for treatment of silicate-containing wastewater in which the silicate is converted to a SiO2 product suitable for disposal in a landfill without further treatment and in which sodium is removed from the wastewater via formation of Na₂CO₃ and NaHCO₃ that can also be disposed of without further treatment. Most advantageously, contemplated processes and methods effectively remove silicate by precipitation and particle growth using carbonization to a controlled end pH of the waste stream. The reaction with CO2 is completed when the pH reaches the 7.5 range (±0.5 pH units). The reaction to produce SiO2 also forms carbonates which naturally buffer the solution to help prevent gelling.

In one exemplary and preferred example, various water, caustic, and sodium silicate-containing waste streams are collected and combined in an equalization tank. It should be noted that such tank will not only serve as a surge tank but will also help mitigating potential adverse impacts on downstream operations due to variations in the volumetric flow and/or chemical composition of the respective streams. Most typically, the equalization tank is configured and operated such as to allow for mixing of the feed streams to achieve a tank effluent with relatively small variations in composition and/or pH. The equalization tank effluent is then sent to a reactor where CO2 gas is added to precipitate solids and neutralize the remaining caustic. Most preferably, the end-of-reaction target pH of the reactor is about 7.5 (±0.5 pH units), which provides suitable conditions for precipitation of the silicates as SiO2. Under most circumstances, such pH ensures a removal efficiency of greater than 98% for the initially dissolved silicon. In further preferred aspects, the precipitate is subjected to a particle growth step in the reaction tank for a duration of about 60-90 minutes, and the water and solids are then sent through a filter press in which the solids are separated from the liquid. The solids are emptied to a bin and sent to a landfill. The liquid that passes through the filter press (filtrate) flows to a sump where optional pH control and adjustment ensure that the pH of the filtrate is between 7 and 9 prior to transfer to further wastewater treatment, including Zero Liquid Discharge (ZLD) ponds. Where the filtrate is sent to a ZLD pond, it should be noted that water will evaporate while sodium carbonates precipitate that can then be sent to a landfill.

In one exemplary aspect of the inventive subject matter, a treatment plant 100 has an equalization tank 110 that is fluidly coupled to at least one sodium silicate-containing wastewater source W via conduit 102 and at least one caustic source A via conduit 104. Both (i.e., wastewater stream and caustic streams) are typically regulated and are allowed to mix in the tank 110. Mixing is preferably facilitated by a mixer 112. Where desired, a pH control unit 114 is operationally coupled to the tank 110 to ascertain a target pH range (preferably above 10.5). pH control can be implemented in numerous manners, preferably by addition of caustic. It is further preferred that the tank 110 is operationally coupled to a temperature control unit 116 that typically includes a heating element in the tank and a sensor/thermostat circuit to maintain the tank contents at a predetermined temperature (preferably between 60 and 170° F.).

Reactor 120 is fluidly coupled to the equalization tank 110 via conduit 118 that delivers the mixture of wastewater and caustic and is further fluidly coupled to a CO2 source that provides a stream of CO2 via conduit 106 to the mixture in the reactor under conditions suitable to allow precipitate formation of silica. Most preferably, the reactor has further pH and temperature control circuits to allow for pH (above 10.5 before the reaction; 7.0 to 9.0 after the reaction) and temperature (60 to 170° F.) control in the reactor. In still further preferred aspects, the reactor is configured to allow for a particle growth step in which the silicate precipitate is allowed to grow SiO2 particles to a size (e.g., greater than 10 micron, more typically at least 25 micron, and most typically at least 50 micron, and often visible particles) that allows removal of the silicate particles using a filter press.

Once the particle growth step has concluded, the slurry is then transferred from the reactor to the filtration unit 130 via conduit 122, typically using one or more pumps (not shown) or gravity feed. The filtration unit produces a solid SiO2 product stream 134 and a filtrate that is removed from the filtration unit 130 via conduit 132. The filtrate is then fed to pond 140 (or other storage implement) for further processing. Most preferably, pond 140 is a ZLD pond where the water portion of the filtrate is evaporated to so allow formation of a sodium carbonates product stream 142 that can be routed to a landfill for safe disposal.

Among other benefits of contemplated configurations and methods, it should be especially appreciated that the pH of the process streams is below hazardous waste levels for both the liquids and the solids. Moreover, the use of CO₂ for neutralization of the mixture of wastewater and caustic is significantly safer to handle than strong acids otherwise used. No further neutralization is required for downstream water treatment. Still further, as the CO₂ forms water soluble sodium carbonates, the water solution is buffered and so reduces the risk of the sodium silicates gelling. It should be noted that gelling is one of the major problems in dealing with sodium silicate solutions which poses problems with disposal. The solids formed in the reaction with CO₂ are non-hazardous and meet landfill requirements. The disposal costs for landfills are considerable and the cost difference between non-hazardous and hazardous materials is significant. Compared to a standard Mg0 process, it should be appreciated that contemplated configurations and methods have higher removal efficiency, result in less solids being sent to a landfill, better filterability, and substantially lower energy requirement.

With respect to suitable equalization tanks, it is contemplated that all tanks and other containments are deemed suitable so long as such tanks and containments allow mixing the sodium silicate-containing wastewater from several different sources and/or mixing of one or more of such water streams with a caustic stream (or other high-pH stream, typically having a pH of at least 11, and most typically at least 12). The ability to mix the wastewater with another solution containing caustic helps stabilize the solution as sodium silicates are more likely to gel depending on a combination of pH, concentration, and temperature. Of course, it should be appreciated that different streams may be combined in different orders, and that the streams may be on-line or from a surge or other storage tank. Caustic streams are most preferably concentrated caustic or caustic waste streams, for example, from a catalyst regeneration process or a caustic gas treatment process. However, numerous alternative caustic streams are also deemed suitable for use herein such as from a caustic silane gas scrubber.

Depending on the size and process volume of the wastewater streams, it should be noted that one or more equalization tanks may be implemented and be configured for continuous and/or batch operation. Regardless of the type of operation, it is generally preferred that the equalization tank includes a mixing unit, a temperature control unit, and a pH control unit. Among other benefits of an equalization tank, it should be appreciated that such tank(s) will advantageously help mitigate the impact of variations in flow and composition on downstream operations. Moreover, such tank(s) will also allow diluting higher silicate concentrations prior to being sent to the reactor. Still further, if any equipment downstream of the equalization tank has unexpected downtime, the equalization tank can act as a surge tank where the tank volume is suitably adjusted. For example, in preferred aspects, the tank has a volume sufficient to allow for production of the silicate-containing solution at a substantially constant composition where at least one of flow and composition of the silicate-containing wastewater stream varies in an amount of at least 10%, more typically at least 20%, and most typically at least 40%.

In especially preferred aspects, the contents of the equalization tank are pumped to the reactor to have the dissolved sodium silicates react with CO2 to so precipitate the silicates as SiO2. The reactor preferably comprises an enclosed tank (as hydrogen evolution may occur where silane gas, or silane scrubbers are present), a mixer, a temperature control unit, and a CO2 supply system. It should be noted that the heater or temperature control unit is typically only used for freeze protection as the reaction rate in the reactor is independent of temperature. Under most circumstances, the reactor temperature is at about 70° F. (±5° F.) as determined from previous experiments (data not shown). However, contemplated processes can be run from approximately 60° F. to 205° F., however, lower temperatures within that range are generally preferred to reduce the energy consumption (it should be noted that the reaction rate was constant over that range). It is still further generally preferred that the CO2 supply system and the height of the water in the reactor are configured and selected such that the contact of CO2 with the liquid is maximized. For example, where suitable, one or more spargers with optional impellers and/or vanes can be installed to better distribute the CO2. Alternatively, multiple nozzles may be used to distribute the CO2 in the reactor. There are numerous configurations and methods for distributing CO2 in a liquid, and all of such known manners are deemed suitable for use herein.

With respect to unreacted CO2 it is generally preferred that the CO2 that escapes from the liquid is recycled, used at another location in the plant, or vented to the atmosphere. After the reaction of the silicates with CO2 has reached a predetermined point (typically a pH controlled endpoint or other equilibrium endpoint), it is generally preferred that the reaction mixture remains in the reactor for a particle growth step. Alternatively, this particle growth may occur in one or more separate vessels. Regardless of the location of the post-reaction growth, it is preferred that a particle growth step under agitation is performed for a period sufficient to allow for growth of the SiO2 precipitate. Most typically, particle growth will proceed to a point at which the SiO2 precipitate has formed particles of a size suitable for filtration with a filter press. For example, under most conditions, particle growth will not require addition of further chemicals to the reaction mixture and the reaction mixture (with the SiO2 precipitate) will remain for about one hour at relatively low agitation levels. Once the particle growth step has reached a predetermined endpoint, the contents of the reaction tank are transferred to a filtration unit for separation of the solid SiO2 and the filtrate containing dissolved Na₂CO₃ and NaHCO₃.

It should be especially noted that in experiments by the inventors such particle growth step significantly promoted the filterability of the reaction mixture, which allowed use of simple filtration equipment such as a filter press. Indeed, without such a growth step, filtration was difficult and required more sophisticated filtration equipment and processes, rendering SiO2 removal inefficient and cost-ineffective. On the other hand, once a growth step was implemented, solid particles were created that were larger and easily filterable. Moreover, the solids formed in such process directly pass government regulated dryness tests to be landfilled as no separate drying steps were required. As above, while growth can be performed in a continuous mode or batch mode, a batch mode is generally preferred. In still further contemplated aspects, the growth step may be enhanced using seed particles, reduced temperature, and/or other additives that promote growth (e.g., co-solvent, typically non-aqueous, or other compounds such as alum or alumina).

With respect to the filtration unit it is typically preferred that the filtration unit is a filter press or other relatively simple separation device. For example, experiments by the inventors have shown that where reactor contents were pumped through a nominal 1 micron filter cloth in a filter press, greater than 98% removal of the initially dissolved silicon was achieved. These solids are dry enough and suitable for immediate disposal in a landfill. However, in alternative aspects, various separation devices other than a filter press are also deemed suitable and include roller presses, a flow-through centrifuge, hydrocyclone separators, gravity settling tanks, etc., which may require additional drying steps for the solid SiO2.

In especially preferred embodiments, contemplated methods and plants include a zero liquid discharge (ZLD) system. It should be noted that CO2 does not introduce any additional water as compared to heretofore common addition of various acids (e.g., HCl, H2SO4, etc.). As the typically greater than 98% removal of the initially dissolved silicon prevents rapid solids buildup in the ZLD pond, cleaning frequency of the pond is significantly decreased.

Consequently, it should be appreciated that particularly preferred methods of treating wastewater will include a step of reacting a silicate-containing solution with CO2 to form dispersed SiO2, and a further step of performing a particle growth step under conditions and for a time effective to produce SiO2 particles from the dispersed SiO2, wherein the particles have a size sufficient to allow filtration of at least 85% of the SiO2 particles from the wastewater. Such particles will typically have a relatively small surface area to mass ratio and thus exhibit significantly reduced water content. Moreover, as the particles are relatively large (smallest dimension typically at least 10 micron, more typically at least 25 micron, and most typically at least 50 micron, and often visible particles), the particles are easy to remove from the liquid. Viewed from a different perspective, a method of treating wastewater is contemplated in which SiO2 and sodium carbonates are formed in a solid form that is suitable for disposal in a landfill.

Therefore, particularly contemplated wastewater treatment plants will include one or more equalization tanks that receive a silicate-containing wastewater stream and at least one alkaline stream (which may or may not comprise silicate). Such plants will further include a reaction tank coupled to the equalization tank, wherein the reaction tank receives a mixture of the silicate-containing wastewater stream and the alkaline stream, and wherein the reaction tank further receives CO2. A filtration unit is typically coupled to the reaction tank to receive a reaction product from the reaction tank and is configured to allow removal of the solid SiO2 from the reaction product to so form a filtrate. In especially contemplated plant, an evaporation pond receives the filtrate from the reaction tank.

Thus, specific embodiments and applications of silicate removal from wastewater have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A method of treating a wastewater stream, comprising:
reacting a silicate-containing solution with CO2 to form dispersed SiO2; and
performing a particle growth step under conditions and for a time effective to produce SiO2 particles from the dispersed SiO2, wherein the particles have a size sufficient to allow filtration of at least 90% of the SiO2 particles from the wastewater.

2. The method of claim 1 wherein the silicate-containing solution is produced by combining a silicate-containing wastewater stream with a caustic process stream.

3. The method of claim 2 wherein the silicate-containing solution is formed in an equalization tank, wherein the tank has a volume sufficient to allow for production of the silicate-containing solution at a substantially constant composition where at least one of flow and composition of the silicate-containing wastewater stream varies in an amount of at least 20%.

4. The method of claim 1 wherein the filtration comprises filtration with a filter press.

5. The method of claim 1 further comprising a step of filtration to thereby remove the SiO2 particles and to form a filtrate.

6. The method of claim 5 further comprising a step of evaporating water from the filtrate to thereby form solid sodium carbonates.

7. A method of treating a silicate-containing wastewater stream, comprising forming SiO2 and sodium carbonates in a solid form that is suitable for disposal in a landfill.

8. The method of claim 7 wherein the SiO2 is solid and formed by precipitation of SiO2 and subsequent particle growth.

9. The method of claim 7 wherein the precipitation of SiO2 is effected by reaction of the silicate-containing wastewater stream with CO2.

10. The method of claim 7 wherein the solid sodium carbonates are formed by filtration and water removal of the silicate-containing wastewater stream after reaction with CO2.

11. The method of claim 10 wherein the water removal is performed in an evaporation pond.

12. The method of claim 7 wherein the silicate-containing wastewater stream is combined with an alkaline waste stream or alkaline stream.

13. A wastewater treatment plant comprising:
an equalization tank fluidly coupled to a source of a silicate-containing wastewater stream and a source of an alkaline stream;
a reaction tank fluidly coupled to the equalization tank to receive a combination of the silicate-containing wastewater stream and the alkaline stream, and further fluidly coupled to a source of CO2;
a filtration unit fluidly coupled to the reaction tank to receive a reaction product from the reaction tank and configured to allow removal of solid SiO2 from the reaction product and to form a filtrate.

14. The plant of claim 13 further comprising an evaporation pond fluidly coupled to the filtration unit to receive the filtrate.

15. The plant of claim 13 further comprising a pH control unit coupled to at least one of the equalization tank and reaction tank, wherein the pH control unit is configured to maintain the pH in at least one of the equalization tank and the reaction tank within a range in which the silicate remains dissolved.

16. The plant of claim 13 further comprising a temperature control circuit coupled to at least one of the equalization tank and the reaction tank to maintain a temperature in the least one of the equalization tank and the reaction tank at a predetermined temperature.

17. The plant of claim 13 wherein the filtration unit comprises a filter press.

18. The plant of claim 13 wherein the filtration unit is configured to allow removal of at least 85% of the solid SiO2 from the reaction product.

19. The plant of claim 13 wherein at least one of the reaction tank and the equalization tank comprises a mixer and a heater.
